(19) United States
(12) Patent Application Publication
(10) Pub. No.: US 2025/0259984 A1
(43) Pub. Date: Aug. 14, 2025

(54) HIGH SHEAR SLURRY MIXING PROCESS AND FORMULATION FOR CATHODE ACTIVE MATERIAL LAYER

(71) Applicant: GM GLOBAL TECHNOLOGY OPERATIONS LLC, Detroit, MI (US)

(72) Inventors: Chuanlong WANG, Troy, MI (US); Roland J. KOESTNER, Plymouth, MA (US); Xiaosong HUANG, Novi, MI (US)

(21) Appl. No.: 18/441,078

(22) Filed: Feb. 14, 2024

(51) Int. Cl. H01M 4/04; H01M 4/02; H01M 4/62

(52) U.S. Cl. CPC H01M 4/0404; H01M 4/623; H01M 4/625; H01M 2004/021; H01M 2004/028

(57) ABSTRACT

A method for manufacturing a cathode electrode includes supplying a mixture for a cathode active material layer including a cathode active material, a conductive additive, a binder, and solvent; mixing the mixture in an extruder/mixer at a predetermined temperature for a predetermined period, wherein the mixture has a viscosity greater than 10 pascal-second (Pa·s) at 20 s⁻¹ during mixing in the extruder/mixer; after mixing in the extruder/mixer, reducing the viscosity of the mixture to less than 10 pascal-second (Pa·s) at 20 s⁻¹; and applying the mixture onto a cathode current collector to form the cathode electrode.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates to battery cells, and more particularly to a high shear electrode mixing process for a cathode electrode of a battery cell.

Electric vehicles (EVs) such as battery electric vehicles (BEVs), hybrid vehicles, and/or fuel cell vehicles include one or more electric machines and a battery system including one or more battery cells, modules, and/or packs. A power control system is used to control charging and/or discharging of the battery system during charging and/or driving.

Battery cells include one or more cathode electrodes, anode electrodes, and separators. The cathode electrodes include a cathode active material layer arranged on a cathode current collector. The anode electrodes include an anode active material layer arranged on an anode current collector.

### SUMMARY

A method for manufacturing a cathode electrode includes supplying a mixture for a cathode active material layer including a cathode active material, a conductive additive, a binder, and solvent; mixing the mixture in an extruder/mixer at a predetermined temperature for a predetermined period, wherein the mixture has a viscosity greater than 10 pascal-second (Pa·s) at 20 s⁻¹ during mixing in the extruder/mixer; after mixing in the extruder/mixer, reducing the viscosity of the mixture to less than 10 pascal-second (Pa·s) at 20 s⁻¹; and applying the mixture onto a cathode current collector to form the cathode electrode.

In other features, during mixing in the extruder/mixer, the mixture has a solids content greater than 70%. The extruder/mixer mixes the mixture with torque greater than or equal to 25 Nm. The extruder/mixer mixes the mixture with torque in a range from 25 Nm to 30 Nm. The predetermined period is in a range from 15 to 20 minutes. The predetermined temperature is less than 40° C. The predetermined temperature is in a range from 25° C. to 30° C.

In other features, the conductive additive includes particles having a specific surface area greater than 125 m2/g. The conductive additive includes particles having a specific surface area greater than 300 m2/g. The conductive additive is selected from a group consisting of acetylene black and furnace black.

In other features, the method includes reducing the viscosity of the mixture includes adding solvent to reduce the viscosity of the mixture to less than 10 pascal-second (Pa·s) at 20 s⁻¹. The binder includes PVDF. The binder further includes at least one of a sulfate and a carboxylate dispersant.

In other features, the cathode active material comprises 90 to 98 wt % of the cathode active material layer, the conductive additive comprises 0.2 to 6 wt % of the cathode active material layer, and the binder comprises 0.5 to 5 wt % of the cathode active material layer. The cathode active material is selected from a group consisting of LFP, LMFP, NMC, NCMA, LMR, and combinations thereof.

A method for manufacturing a cathode electrode includes supplying a mixture for a cathode active material layer including a cathode active material, a conductive additive, a binder, and solvent, The conductive additive includes particles having a specific surface area greater than 125 m²/g. The method includes mixing the mixture in an extruder/mixer at a predetermined temperature for a predetermined period, wherein the mixture has a viscosity greater than 10 pascal-second (Pa·s) at 20 s⁻¹ during mixing in the extruder/mixer and the extruder/mixer mixes the mixture with torque greater than or equal to 25 Nm; after mixing in the extruder/mixer, reducing the viscosity of the mixture to less than 10 pascal-second (Pa·s) at 20 s⁻¹; and applying the mixture onto a cathode current collector to form the cathode electrode.

In other features, the predetermined period is in a range from 15 to 20 minutes. The predetermined temperature is less than 40° C. The conductive additive includes particles having a specific surface area greater than 300 m²/g.

In other features, the cathode active material comprises 90 to 98 wt % of the cathode active material layer, the cathode active material is selected from a group consisting of LFP, LMFP, NMC, NCMA, LMR, and combinations thereof, the conductive additive comprises 0.2 to 6 wt % of the cathode active material layer, and the binder comprises 0.5 to 5 wt % of the cathode active material layer.

Further areas of applicability of the present disclosure will become apparent from the detailed description, the claims, and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a side cross section of an example of a battery cell including anode electrodes, cathode electrodes, and separators according to the present disclosure;

FIG. 2 is a side cross section of an example of a cathode electrode according to the present disclosure;

FIG. 3A is a side cross section of an example of a process for manufacturing a cathode electrode using high shear mixing according to the present disclosure;

FIGS. 3B and 3C are examples of viscosity reducer and slurry dispensers according to the present disclosure;

FIG. 4A shows examples of discharge specific capacity as a function of cycles for cathode electrodes manufactured with a conventional process and a high shear electrode mixing process according to the present disclosure;

FIG. 4B shows examples of capacity retention percentage as a function of cycles for cathode electrodes manufactured with a conventional process and a high shear electrode mixing process according to the present disclosure;

FIG. 5A shows examples of discharge capacity retention as a function of cycles for cathode electrodes manufactured with a conventional process and a high shear electrode mixing process according to the present disclosure; and

FIG. 5B shows examples of capacity as a function of cycles at different discharge rates for cathode electrodes manufactured with a conventional process and a high shear electrode mixing process according to the present disclosure.

In the drawings, reference numbers may be reused to identify similar and/or identical elements.

### DETAILED DESCRIPTION

While battery cells according to the present disclosure are shown in the context of electric vehicles, the battery cells can be used in stationary applications and/or other applications.

The present disclosure relates to a high-shear electrode mixing process for manufacturing a cathode active material layer of a cathode electrode. The high-shear electrode mixing process uses a screw type extruder/mixer providing high shear/torque. In some examples, a mixture for the cathode active material layer includes one or more cathode active materials, a conductive additive, a binder, and solvent. In some examples, the mixture has a solids content greater than 70%. For active material with a higher specific surface area (i.e. LFP), the solid content is in a range from 70% to 85%. In some examples, the conductive additive includes particles having a high specific surface area (e.g., greater than 125 m²/g). The specific surface area (SSA) is a property of solids defined as the total surface area (SA) of a material per unit mass.

Among other advantages, the high-shear electrode mixing process allows carbon nanotubes (CNT) to be eliminated from the conductive filler in the cathode active material layer without loss of performance. CNT have a cost that is 5 to 200 times more than the cost of other less expensive conductive fillers such as acetylene black (AB) or furnace black (FB). The kneading process at high solids is able to mill the initial agglomerate structure of the carbon black, while agglomerate growth after mill is then restricted by the limited particle mobility at high solids which thereby disperses the conductive carbon effectively through the electrode layer.

In some examples, the mixture for the cathode active material layer is mixed/sheared in the screw type extruder/mixer with high shear/torque (e.g., in a range from 25 Nm to 30 Nm) for a predetermined mixing period (e.g., 15 to 20 minutes). In some examples, the viscosity of the mixture during mixing is greater than 10 pascal-second (Pa·s) at 20 s⁻¹.

In some examples, a mixing chamber of the screw type extruder/mixer is at least 75% full during mixing. In some examples, the temperature is less than 40° C. during operation (e.g., 25° C. to 30° C.). In some examples, specific energy input is in a range from 0.4 to 0.5 KJ/g of material.

In some examples, an output of the screw type extruder/mixer feeds a viscosity reducer and slurry dispenser including a slotted die at an output thereof. In some examples, the viscosity reducer and slurry dispenser is configured to add additional solvent to reduce the viscosity of the extruded cathode active material layer to less than 10 Pa·s at 20 s⁻¹ before casting.

Referring now to FIG. 1, a battery cell 10 includes C cathode electrodes 20, A anode electrodes 40, and S separators 32 arranged in a predetermined sequence in a battery cell stack 12, where C, S and A are integers greater than zero. The C cathode electrodes 20-1, 20-2, . . . , and 20-C include cathode active material layers 24 arranged on one or both sides of a cathode current collector 26. The A anode electrodes 40-1, 40-2, . . . , and 40-A include anode active material layers 42 arranged on one or both sides of the anode current collectors 46. During charging/discharging, the A anode electrodes 40 and the C cathode electrodes 20 exchange lithium ions.

In some examples, the cathode active material layer 24 comprises an extrusion including one or more active materials, one or more conductive additives, and/or one or more binder materials that are cast onto the cathode current collector (e.g., using a wet roll-to-roll process).

In some examples, the cathode current collector 26 and/or the anode current collector 46 comprises metal foil, metal mesh, perforated metal, 3 dimensional (3D) metal foam, and/or expanded metal. In some examples, the current collectors are made of one or more materials selected from a group consisting of copper, stainless steel, brass, bronze, zinc, aluminum, and/or alloys thereof. External tabs 28 and 48 are connected to the current collectors of the cathode electrodes and anode electrodes, respectively, and can be arranged on the same or different sides of the battery cell stack 12. The external tabs 28 and 48 are connected to terminals of the battery cells.

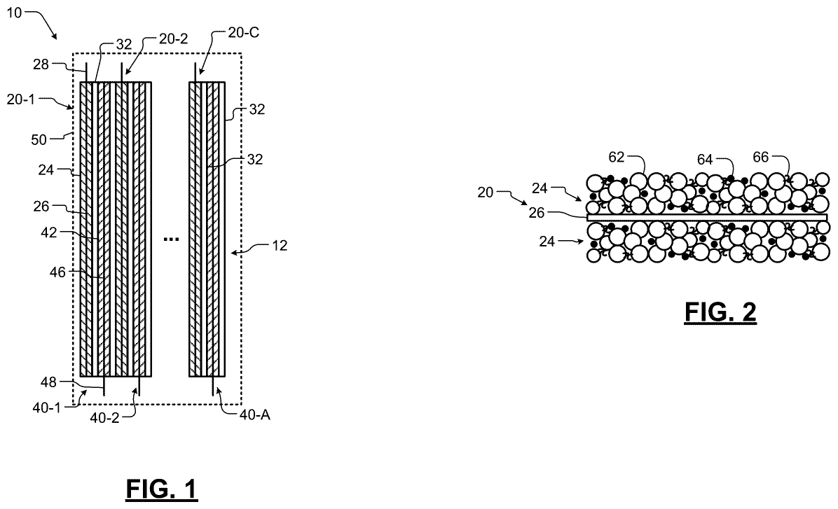

Referring now to FIG. 2, the C cathode electrodes 20 are shown in further detail. The cathode active material layer 24 of the C cathode electrodes 20 includes a cathode active material 62, a conductive additive 64, and a binder 66. The cathode active material layer 24 is extruded using a high-shear electrode mixing process as described herein.

In some examples, the cathode active material comprises 90 wt. % to 98 wt. % of the cathode active material layer, the conductive filler comprises 0.2 wt. % to 6 wt. % of the cathode active material layer, and the binder comprises 0.5 wt. % to 5 wt. % of the cathode active material layer. In some examples, the cathode active material comprises lithium iron phosphate (LFP), lithium manganese iron phosphate (LMFP), lithium nickel manganese carbon (NMC), lithium nickel carbon manganese aluminum (NCMA), lithium-and manganese-rich (LMR), and combinations thereof.

In some examples, the conductive filler includes particulates having a specific surface area greater than 125 m²/g. In some examples, the conductive filler includes acetylene black (AB) or furnace black with a specific surface area (e.g., greater than 125, 200 or 300 m²/g). In some examples, the binder comprises polyvinylidene difluoride (PVDF). In some examples, the binder further comprises an optional sulfate and/or carboxylate dispersant.

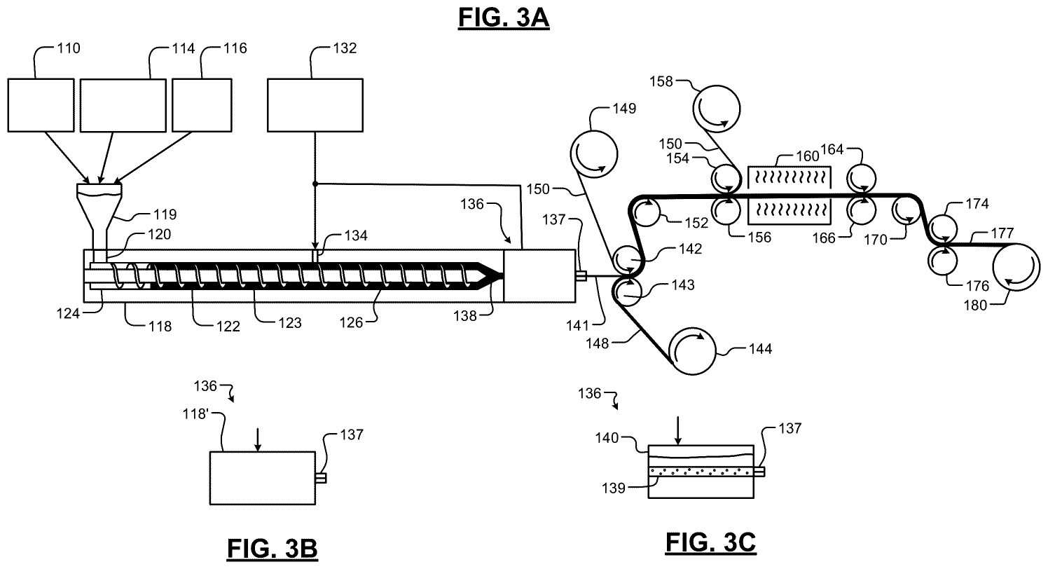

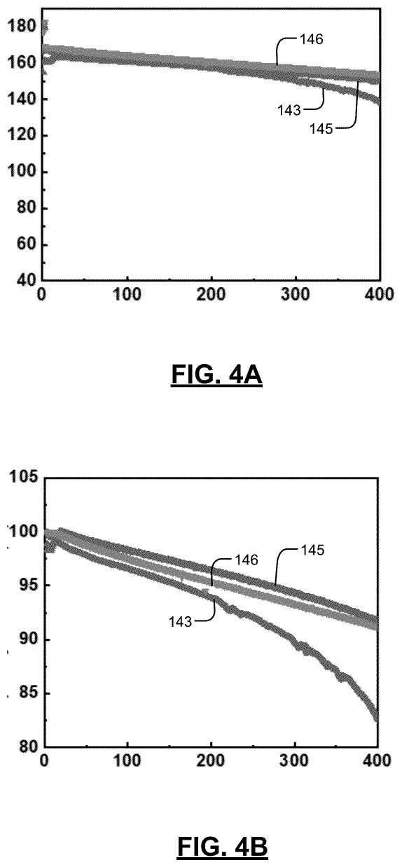

Referring now to FIGS. 3A to 3C, manufacturing of a cathode active material layer using a high-shear electrode mixing process and further processing of the cathode active material layer into cathode electrodes is shown. In FIG. 3A, a cathode active material 110, a conductive additive 114, and a binder 116 are supplied to an inlet 120 of an extruder/mixer 118 (via an optional funnel 119).

The extruder/mixer 118 includes an elongated cavity 122. A screw 123 including a shaft 124 with an inclined plane 126 is located in the elongated cavity 122 and is configured to rotate. The screw 123 moves/mixes the mixture through the elongated cavity 122. One or more inlets 134 are arranged along the extruder/mixer 118 to allow solvent to be added if needed at one or more lateral locations into the elongated cavity 122 to control or adjust viscosity.

Mixed and sheared cathode active material from the extruder/mixer 118 is output to a viscosity reducer and slurry dispenser 136. The viscosity reducer and slurry dispenser 136 includes a slotted die 137 acting as a slurry dispenser at an output thereof. The viscosity reducer and slurry dispenser 136 receives the mixture and adds additional solvent to the mixture to reduce the viscosity of mixture for the cathode active material layer.

In FIG. 3B, an example of the viscosity reducer and slurry dispenser 136 includes another extruder/mixer 118′ that adds additional solvent to the mixture to reduce viscosity. In FIG. 3C, an example of the viscosity reducer and slurry dispenser 136 includes a conduit 139 that receives the mixture from the extruder/mixer 118. The conduit 139 is arranged in a slurry reservoir 140. The conduit 139 includes one or more inlets or holes to receive solvent to reduce the viscosity of the mixture before passing through the slotted die 137 and further processing is performed. In some examples, the solvent is supplied by lines supplying solvent at elevated pressure.

An active material layer 141 with the reduced viscosity is fed through the slotted die (or a reverse comma method is used) and between a pair of rollers 142 and 143. A roll 144 supplies a layer such as a current collector 148 between the pair of rollers 142 and 143. In some examples, a roll 149 supplies an optional release layer 150 between the pair of rollers 142 and 143. The current collector 148, the extruded active material layer 141, and the optional release layer 150 may optionally pass over one or more guide rollers 152 before being fed between rollers 154 and 156. The optional release layer 150 may be removed and collected on a roll 158.

The current collector 148 and the extruded active material layer 141 pass through an oven operating at a temperature in a predetermined range to dry the extruded mixture (e.g., to remove the solvent). The current collector 148 and the extruded active material layer 141 are dried in the oven and then guided between rollers 164 and 166, over an optional guide roller 170, and pressed and/or heated by rollers 174 and 176 to a predetermined thickness and/or porosity. After passing through the rollers 174 and 176, the cathode electrode 177 including the current collector 148 and the extruded active material layer 141 is collected on a roll 180.

Referring now to FIGS. 4A and 4B, performance of various examples of conductive fillers are shown for a battery cell including a graphite anode electrode and a cathode including NCMA and LMFP (70:30) and PVDF binder at 80% solids content. The electrolyte includes 1M LiPF₆ in ethylene carbonate (EC), diethyl carbonate (DEC), and ethyl methyl carbonate (EMC) (at a ratio of 1:1:1), 0.5 wt % vinyl ethylene carbonate, 1.0 wt % vinylene carbonate, and 1.5 wt % propane sultone.

A first example at 143 includes conductive filler including carbon black, 2D graphene nanoplate (GNP), and 1D single-wall carbon nanotubes (SWCNT) (e.g., at 0.8 wt %, 0.6 wt %, and 0.1 wt %). A second example at 145 includes conductive filler including carbon black and SWCNT (e.g., at 1.4 wt % and 0.1 wt %). A third example at 146 includes conductive filler including acetylene black (e.g., at 1.5 wt %) mixed with high shear as described herein. As can be seen, the third example 146 without SWCNT performed well. Therefore, high shear mixing according to the present disclosure can be used to eliminate CNTs, which reduces the cost of the cathode electrode without sacrificing performance. Furthermore, effective mixing of the formulation with high surface area acetylene black (AB) enables stable cell electrochemical performance.

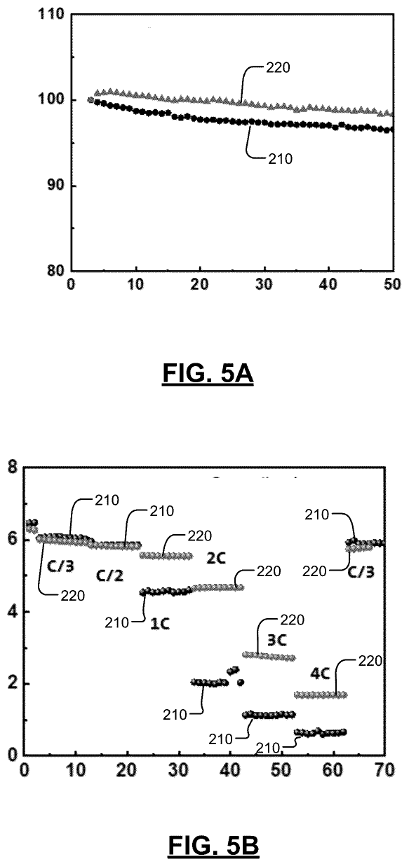

Referring now to FIGS. 5A and 5B, performance of examples manufactured using a conventional mixing process (at 210) and a high shear mixing process described herein (at 220) are shown. In this example, the anode electrode includes 5.5% SiOx-graphite. The high shear mixing example includes cathode active material layer 97wt % NCMA-LMFP (70:30), 1.5 wt % acetylene black with high specific surface area (e.g., greater than 125 m²/g), and 1.5wt % PVDF. The conventional process example includes 97wt % NCMA-LMFP (70:30), 0.8wt % SuperP, 0.6wt % GNP, 0.1wt % 1D CNT, 1.2wt % PVDF, and 0.3wt % acetylene black.

In FIG. 5A, the electrolyte included 1M LiPF₆ in EC:DMC (3:7), 2% fluoroethylene carbonate (FEC), and 1% vinylene carbonate (VC). As can be seen, the discharge capacity retention percentage of the high shear mixing example at 220 was greater than the conventional process example at 210. In FIG. 5B, the electrolyte included 1M LiPF6 in EC:DMC (3:7) and 1% lithium difluorooxalatoborate (LiDFOB). As can be seen, the capacity of the high shear mixing example at 220 was approximately equal to or greater than the conventional process example at 210 for different discharging rates.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

What is claimed is:

1. A method for manufacturing a cathode electrode, comprising:
supplying a mixture for a cathode active material layer including a cathode active material, a conductive additive, a binder, and solvent;
mixing the mixture in an extruder/mixer at a predetermined temperature for a predetermined period, wherein the mixture has a viscosity greater than 10 pascal-second (Pa·s) at 20 s⁻¹ during mixing in the extruder/mixer;
after mixing in the extruder/mixer, reducing the viscosity of the mixture to less than 10 pascal-second (Pa·s) at 20 s⁻¹; and
applying the mixture onto a cathode current collector to form the cathode electrode.

2. The method of claim 1, wherein, during mixing in the extruder/mixer, the mixture has a solids content greater than 70%.

3. The method of claim 1, wherein the extruder/mixer mixes the mixture with torque greater than or equal to 25 Nm.

4. The method of claim 1, wherein the extruder/mixer mixes the mixture with torque in a range from 25 Nm to 30 Nm.

5. The method of claim 1, wherein the predetermined period is in a range from 15 to 20 minutes.

6. The method of claim 1, wherein the predetermined temperature is less than 40° C.

7. The method of claim 1, wherein the predetermined temperature is in a range from 25° C. to 30° C.

8. The method of claim 1, wherein the conductive additive includes particles having a specific surface area greater than 125 m²/g.

9. The method of claim 1, wherein the conductive additive includes particles having a specific surface area greater than 300 m²/g.

10. The method of claim 8, wherein the conductive additive is selected from a group consisting of acetylene black and furnace black.

11. The method of claim 1, wherein reducing the viscosity of the mixture includes adding solvent to reduce the viscosity of the mixture to less than 10 pascal-second (Pa·s) at 20 s⁻¹.

12. The method of claim 1, wherein the binder includes PVDF.

13. The method of claim 12, wherein the binder further includes at least one of a sulfate and a carboxylate dispersant.

14. The method of claim 1, wherein:
the cathode active material comprises 90 to 98 wt % of the cathode active material layer, the conductive additive comprises 0.2 to 6 wt % of the cathode active material layer, and the binder comprises 0.5 to 5 wt % of the cathode active material layer.

15. The method of claim 1, wherein the cathode active material is selected from a group consisting of LFP, LMFP, NMC, NCMA, LMR, and combinations thereof.

16. A method for manufacturing a cathode electrode, comprising:
supplying a mixture for a cathode active material layer including a cathode active material, a conductive additive, a binder, and solvent,
wherein the conductive additive includes particles having a specific surface area greater than 125 m²/g;
mixing the mixture in an extruder/mixer at a predetermined temperature for a predetermined period, wherein the mixture has a viscosity greater than 10 pascal-second (Pa·s) at 20 s⁻¹ during mixing in the extruder/mixer and the extruder/mixer mixes the mixture with torque greater than or equal to 25 Nm;
after mixing in the extruder/mixer, reducing the viscosity of the mixture to less than 10 pascal-second (Pa·s) at 20 s⁻¹; and
applying the mixture onto a cathode current collector to form the cathode electrode.

17. The method of claim 16, wherein the predetermined period is in a range from 15 to 20 minutes.

18. The method of claim 16, wherein the predetermined temperature is less than 40° C.

19. The method of claim 16, wherein the conductive additive includes particles having a specific surface area greater than 300 m²/g.

20. The method of claim 16, wherein:
the cathode active material comprises 90 to 98 wt % of the cathode active material layer,
the cathode active material is selected from a group consisting of LFP, LMFP, NMC, NCMA, LMR, and combinations thereof,
the conductive additive comprises 0.2 to 6 wt % of the cathode active material layer, and
the binder comprises 0.5 to 5 wt % of the cathode active material layer.
